(19) United States
(12) Patent Application Publication
(10) Pub. No.: US 2026/0246685 A1
(43) Pub. Date: Aug. 20, 2026

(54) AUTOMATED ASSISTANT FRAMEWORK INCLUDING ORCHESTRATOR AND ASSISTANTS

(71) Applicant: Cisco Technology, Inc., San Jose, CA (US)

(72) Inventors: Prashanth Arun, San Jose, CA (US); Dhananjay Sampath, Sunnyvale, CA (US); Arjun Sambamoorthy, San Jose, CA (US); Anand Raghavan, Santa Clara, CA (US)

(21) Appl. No.: 19/171,178

(22) Filed: Apr. 4, 2025

Related U.S. Application Data
(60) Provisional application No. 63/761,120, filed on Feb. 20, 2025.

(51) Int. Cl. H04L 41/046; G06N 20/00; H04L 9/40

(52) U.S. Cl. CPC H04L 41/046; G06N 20/00; H04L 63/0263; H04L 63/08

(57) ABSTRACT

An automated assistant framework can include an orchestrator and assistants managed thereby. The framework enables orchestration of network management tool assistants included in multiple different network management tools. The orchestrator can comprise a trained ML module configured to interact with a user such as a network administrator. The orchestrator can receive a request from the user and can orchestrate a response to the request, wherein orchestrating the response includes formulating network assistant requests for one or more network management tool assistants, using the formulated network assistant requests to engage network management tool assistants, and combining the resulting outputs from the network management tool assistants.

### RELATED APPLICATIONS

This application claims priority to U.S. Provisional Patent Application No. 63/761,120 filed on Feb. 20, 2025, the entire contents of which are incorporated herein by reference for all purposes.

### TECHNICAL FIELD

The present disclosure relates generally to management and security of computer networks, and to tools for managing computer networks in particular.

### BACKGROUND

Networking technology companies such as CISCO® and others offer many different network management tools to their customers, and the customers often run multiple network management tools concurrently in their enterprise networks. Example network management tools include, e.g., Cisco Secure Access, Cisco Duo, Cisco Catalyst Controller, Cisco Firewall, Cisco Meraki, and others. Customers may run several or all of these tools concurrently, optionally along with other tools, to manage different aspects of their enterprise networks.

In some cases, customers may use a set of network management tools as a bundle that serves most of their network management and security needs. The tools may be designed to cooperate or interoperate to some degree, e.g., by being able to access similar data stores or by being designed to output events or other messages in formats which can be recognized by other tools in a bundle.

Meanwhile, network management tools are increasingly including sophisticated assistants, which may include artificial intelligence (AI) or machine learning (ML) modules (AI and ML are used interchangeably herein). Network management tool assistants are generally designed to receive questions or requests from a user, such as a network administrator. In response to a request, a network management tool assistant can determine an intent associated with the request and respond, e.g., by supplying useful information, asking the user for additional information, or possibly activating functions of the network management tool in accordance with the request.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture comprising various devices in a network, the network including network management device(s) equipped with an orchestrator and network management tools, the network management tools comprising automated interaction tools which interact with the orchestrator, in accordance with various aspects of the technologies disclosed herein.

FIG. 2 illustrates an example orchestrator and operations thereof, in accordance with various aspects of the technologies disclosed herein.

FIG. 3 illustrates an example series of interactions which may be performed by an orchestrator, the series of interactions including interactions with a user and interactions with multiple different assistants, in accordance with various aspects of the technologies disclosed herein.

FIG. 4 illustrates an example packet switching system that can be utilized to implement devices in accordance with various aspects of the technologies disclosed herein.

FIG. 5 illustrates an example node that can be utilized to implement devices in accordance with various aspects of the technologies disclosed herein.

FIG. 6 illustrates an example computer hardware architecture that can implement devices in accordance with various aspects of the technologies disclosed herein.

FIG. 7 is a flow diagram that illustrates an example method involving an orchestrator, in accordance with various aspects of the technologies disclosed herein.

### DESCRIPTION OF EXAMPLE EMBODIMENTS

### Overview

This disclosure describes techniques that can be performed in connection with operating an automated assistant framework including an orchestrator and assistants. Example techniques can include receiving a request by an orchestrator and determining, by the orchestrator in response to the request, different respective network assistant requests for different respective network management tool assistants. The example techniques can further include submitting, by the orchestrator, the different respective network assistant requests to the different respective network management tool assistants, and receiving, by the orchestrator, different respective network assistant outputs from the different respective network management tool assistants. The example techniques can further include combining, by the orchestrator, the different respective network assistant outputs into a combined output, and outputting, by the orchestrator, the combined output in response to the request. In some examples, the orchestrator and the different respective network management tool assistants can be implemented via AI or ML modules.

The techniques described herein may be performed by one or more computing devices comprising one or more processors and one or more computer-readable media storing computer-executable instructions that, when executed by the one or more processors, cause the one or more processors to perform the methods disclosed herein. The techniques described herein may also be accomplished using non-transitory computer-readable media storing computer-executable instructions that, when executed by one or more processors, perform the methods carried out by the network controller device.

### Example Embodiments

In an example according to this disclosure, an orchestrator is provided to orchestrate use of network management tool assistants included in multiple different network management tools. The orchestrator can comprise a trained ML module configured to interact with a user such as a network administrator. The orchestrator can receive a request from the user and can be configured to orchestrate a response to the request, wherein orchestrating the response includes formulating network assistant requests for one or more network management tool assistants, using the formulated network assistant requests to engage network management tool assistants, and combining the resulting outputs from the network management tool assistants.

In some embodiments, the orchestrator described herein can be described as an umbrella AI assistant that can integrate multiple independent capabilities/agents/tools corresponding to multiple product suites, in an architecture that allows for easy integration of new network management tool capabilities into the orchestrator.

With the rapid adoption of AI, networking companies have begun to roll out automated interaction tools, also referred to herein as assistants or AI assistants, to support customers that utilize their various network management tools. For instance, a networking company might roll out an AI assistant that is specialized to support customers of a secure access tool, such as Cisco Secure Access, and a networking company might roll out another AI assistant that is specialized to support customers of a virtual private network (VPN) tool.

Customers increasingly expect a cohesive experience across all online touchpoints, regardless of which product or service they are engaging with. However, the segmented nature of product-based AI assistants creates fragmentation that leads to inconsistent responses, varied customer service quality, and disjointed interactions for users moving between network management tool products. It is very difficult to provide a unified experience to customers in the networking and network security domain due to the complexities of the different domains being managed. A generic off-the-shelf AI model will not be able to orchestrate these various AI assistants adequately due to the complex nature of the different subdomains.

In some examples, the orchestrator described herein can provide a unified AI assistant experience that allows for different AI assistants from different network management tools to integrate into one common AI Assistant experience. The orchestrator can provide a common platform through which AI assistants that are specialized for a wide variety of networking domains can be integrated into one overarching framework and through which customers can ask questions regarding any of their network management tools. The orchestrator can orchestrate different AI assistants that are specialized to support different network management tools and different use cases, and which have different capabilities.

In some aspects, this disclosure provides a framework including an orchestrator and automated interaction tools (assistants) for each product of a suite of products. The orchestrator is adapted to provide a unified interface that enables uniform user interactions with multiple, up to all, of the products in the product suite. The orchestrator may be configured to perform operations as simple as taking a particular customer request and routing it to an appropriate AI assistant. In more complex use cases, the orchestrator can interact with multiple different AI assistants in order to orchestrate a response to a user request.

The orchestrator can be configured to identify a user that submits a request. The orchestrator can be configured to receive a submitted request/question and determine an intent thereof. The orchestrator can be configured to determine which network management tools in a suite or bundle of network management tools are relevant to a request, and which specialized AI assistants may therefore be involved in responding to the request. The orchestrator can be configured to route the request to appropriate AI assistants.

In more complicated use cases, the orchestrator can determine that a particular user request cannot be handled by a single AI assistant because the request requires knowledge from multiple disparate domains. In these examples, the orchestrator can determine which AI assistants for which network management tools are to be called in order to answer a request. The orchestrator can call the appropriate AI assistants and combine outputs from each into a comprehensive combined response for the user.

In an example troubleshooting use case, a customer may have multiple network management tools deployed in in a network, a customer may submit a request for information regarding why the network is running slowly. The orchestrator may first interact with a firewall AI assistant in order to ascertain what is happening to particular traffic in the network. The orchestrator may thereby learn that the firewall is working well. The orchestrator can continue to interact with other AI assistants, such as AI assistants for a VPN, Secure Access, Wi-Fi endpoints, etc. The orchestrator may submit requests to these AI assistants in order to troubleshoot the issue that the user is experiencing. The orchestrator can respond to the user after interacting with multiple AI assistants to troubleshoot the issue presented in the user request.

The disclosed orchestrator can be equipped with information regarding the different network management tools in a product suite of a networking company. For example, the disclosed orchestrator can understand the capabilities of the AI assistants for each of these network management tools, and the orchestrator can be configured to orchestrate calling the AI assistants based on the requests from users.

In various examples, the orchestrator can include an orchestration layer, intelligent routing functions, and planning functions based on capabilities of different AI assistants. The orchestrator can be configured to conduct complex reasoning over constituent tools and AI assistants, enabling it to output and follow a series of steps comprising calling different AI assistants with different tasks to respond to an original user request. The orchestrator can furthermore be configured to learn/adapt to particular customer network environments and users thereof, thereby improving its response orchestration over time and becoming customized to suit the different circumstances presented by different customer network environments.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

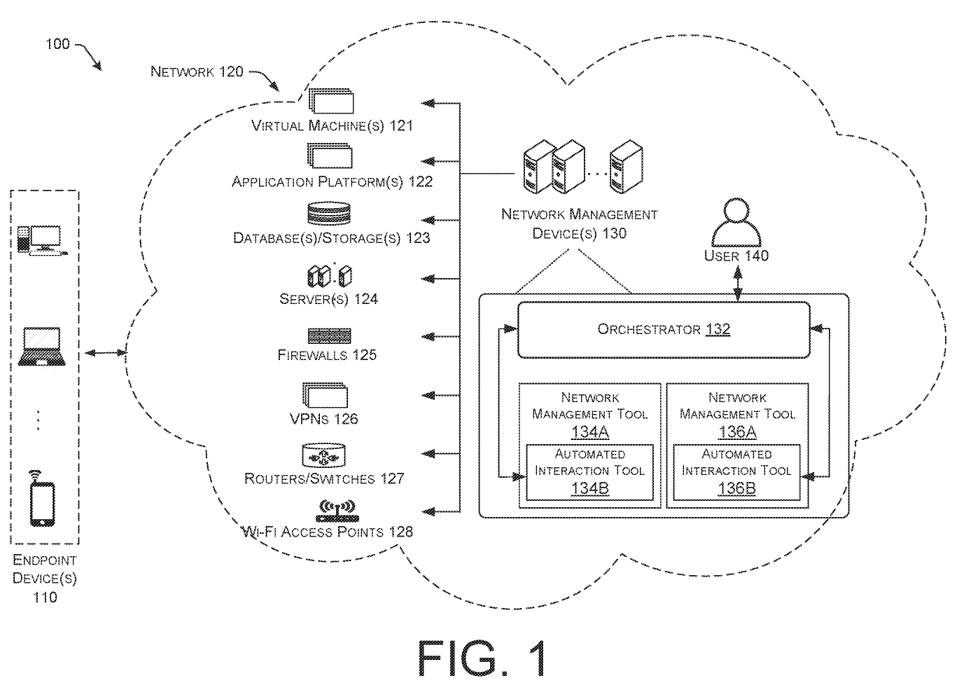

FIG. 1 illustrates an example architecture 100 comprising various devices in a network 120, the network 120 including network management device(s) 130 equipped with an orchestrator 132 and network management tools 134A, 136A, the network management tools 134A, 136A comprising automated interaction tools 134B, 136B which interact with the orchestrator 132, in accordance with various aspects of the technologies disclosed herein. FIG. 1 comprises endpoint device(s) 110 and the network 120. The network 120 can include virtual machine(s) 121, application platform(s) 122, database(s)/storage(s) 123, server(s) 124, firewalls 125, VPNs 126, routers/switches 127, Wi-Fi Access Points 128, and the network management device(s) 130. The network management device(s) 130 can comprise the orchestrator 132 and network management tools 134A, 136A. Alternatively, the orchestrator 132 and/or network management tools 134A, 136A can be implemented at any devices in the network 120 or in the endpoint device(s) 110.

The orchestrator 132 and the automated interaction tools 134B, 136B can optionally be implemented as one or more trained machine learning (ML) or artificial intelligence (AI) modules. In some examples, the orchestrator 132 can receive a request, e.g., a text or voice input from a user 140, and the orchestrator 132 can orchestrate interactions with the automated interaction tools 134B, 136B, and combine outputs from the automated interaction tools 134B, 136B, thereby generating a combined response to the request.

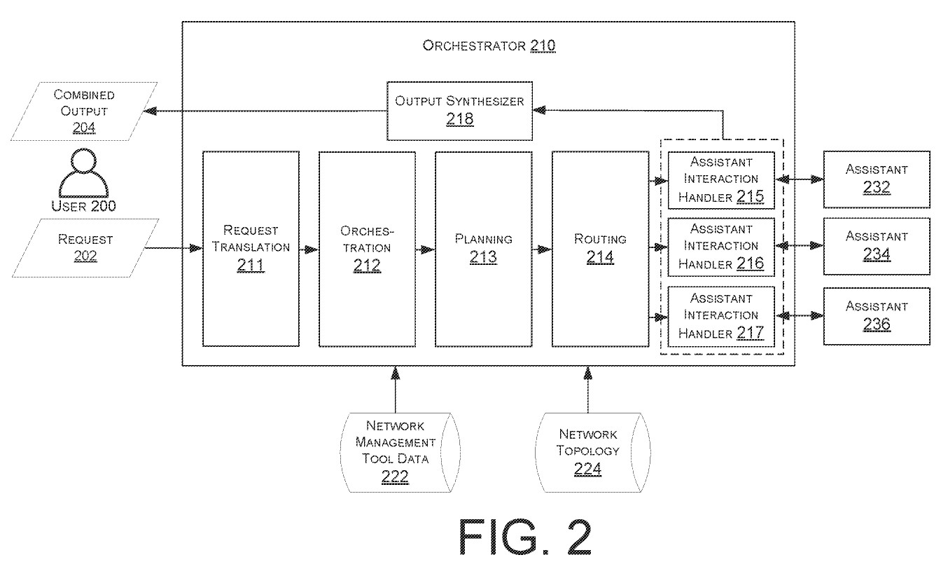

The automated interaction tools 134B, 136B illustrated in FIG. 1 may also be referred to herein as assistants, AI assistants, or network management tool assistants. The term “assistant” is used for brevity in FIG. 2 and subsequent figures. In general, the assistants / automated interaction tools 134B, 136B can provide, for example, troubleshooting support for the network management tools 134A, 136A. However, the automated interaction tools 134B, 136B need not be limited to troubleshooting functions. The automated interaction tools 134B, 136B can also provide, for example, general product access and use functions. In one example, the network management tools 134A, 136A can provide security policy management, access policy management, network management, device management, and other function. This disclosure is not limited to any particular network management tool types or functions.

One example configuration of the orchestrator 132 is provided in FIG. 2. In general, the orchestrator 132 can orchestrate interactions with automated interaction tools 134B, 136B for example by interpreting an intent of the request and determining an orchestration strategy to respond to the request. The orchestration strategy can comprise a response goal and an action plan. The response goal can comprise, e.g., a goal of providing determined information to the user 140 in response to the request, or a goal of performing one or more actions (such as modifying network configuration information) in response to the request.

The action plan can comprise, e.g., one or more operations to be performed to achieve the response goal. The action plan can include interactions between the orchestrator 132 and the automated interaction tools 134B, 136B, as well as any pre or post processing conducted by the orchestrator 132. Example preprocessing can include producing interaction inputs for the automated interaction tools 134B, 136B, while example postprocessing can include combining interaction outputs from the automated interaction tools 134B, 136B. The orchestrator 132 can determine an orchestration strategy based on available network 120 information (e.g., information pertaining to the devices, applications, and configuration settings in the network 120) as well as capabilities of the network management tools 134A, 136A and their automated interaction tools 134B, 136B.

Developing an orchestration strategy can comprise determining, by the orchestrator 132 in response to the request, different respective requests for different respective automated interaction tools 134B, 136B. In some instances, the requests can submitted to the automated interaction tools 134B, 136B in parallel, while in other instances, the requests can be submitted to the automated interaction tools 134B, 136B serially.

In some instances, one or more subsequent requests may be based in part on information obtained from one or more previous requests, and the orchestrator 132 can be configured to formulate the subsequent requests based on automated interaction tools’ 134B, 136B responses to the one or more previous requests. Furthermore, in some instances, the orchestrator 132 may engage in a series of multiple interactions with a first one of the automated interaction tools, e.g., automated interaction tool 134B, and the orchestrator 132 may then perform one or more further interactions with a second or subsequent one of the automated interaction tools, e.g., automated interaction tools 136B. Any of the subsequent interactions may optionally be based on the previous interactions.

The orchestrator 132 can receive different respective outputs from the different respective automated interaction tools 134B, 136B, and the orchestrator 132 can combine the different respective outputs into a combined output. Combining outputs can comprise simply placing all received outputs in a combined data structure, or combining outputs can comprise modifying one or more received outputs based on other received outputs or applying formulas or any desired data modification processing to the received outputs. After generating the combined output, the orchestrator 132 can provide the combined output to the user 140 in response to the user’s 14 original request.

The different respective network management tools 134A, 136A can comprise, e.g., tools for managing any of the virtual machine(s) 121, application platform(s) 122, database(s)/storage(s) 123, server(s) 124, firewalls 125, VPNs 126, routers/switches 127, Wi-Fi Access Points 128, and/or endpoint device(s) 110 of the network 120. Some example network management tools include a secure client network management tool to manage a secure client function installed on endpoint devices 110 of the network 120, a user authentication network management tool to manage a user authentication function of the network 120, a firewall network management tool to manage firewalls 125 of the network 120, and a Wi-Fi access point network management tool to manage a Wi-Fi access points 128 of the network 120. In some examples, the different respective automated interaction tools 134B, 136B are for different respective network management tools 134A, 136A included in a bundle or suite of related network management tools. For example, a networking company such as CISCO® may make and sell network management tools in a bundle which provides complimentary functions to manage the network 120.

In one example use of the orchestrator 132, the user 140 may submit a request in the form of a question, e.g., “why is the network running slow?” The orchestrator 132 can receive and interpret the request as a request for information pertaining to where there may be network traffic congestion in the network 120. The orchestrator 132 can interact with, e.g., the automated interaction tool 134B by requesting information about packet loss at the firewalls 125. Furthermore, the orchestrator 132 can interact with, e.g., the automated interaction tool 136B by requesting information about packet loss at the VPNs 126. The orchestrator 132 can interact with additional automated interaction tools to request information about packet loss at other network 120 elements. The orchestrator 132 can then compare packet loss information returned by the automated interaction tools 134B, 136B, and can generate a combined output which summarizes the primary areas of network 120 packet loss. The combined output may also include recommended remediation or further information gathering steps performable by user 140.

The orchestrator 132 and the automated interaction tools 134B, 136B can be implemented using AI, as noted above. There have been advances in AI that have enabled chatbots and other AI systems to perform complex tasks that normally require human intelligence, such as perceiving, synthesizing, and inferring information. Generally speaking, AI systems and models ingest large amounts of data (or “training data”), analyze this data to identify correlations and patterns, and use these patterns to make predictions about future states. Although AI programs and algorithms have been around for decades, the amount of data and computing power needed to train AI models that are useful for humans has not existed. However, there have been various technological breakthroughs and advances that have accelerated the usefulness of AI, such as advent of cloud computing that provides effectively unlimited compute, advances in specialized hardware (e.g., graphics processing units (GPUs)) that efficiently train and run these AI models, and the discovery of more efficient training algorithms.

Generative AI is a type of artificial intelligence where models are used to create (or “generate”) new content based on inputs, often in the form of prompts from users. One type of generative AI model is particularly effective at generating text, specifically, the large language model (LLM). LLMs are trained on large sets or corpuses of text data to perceive and infer context from user queries, understand a broader range of queries, and generate human-like textual responses to the queries. LLM-backed interactive agents are becoming increasingly popular among users due to their ability to perform complex tasks on behalf of users. The orchestrator 132 can be implemented as an LLM-backed interactive agent in some examples.

An LLM used to implement the orchestrator 132 can be designed according to neural network architecture in some instances. One type of neural network architecture that has gained popularity due to its ability to reduce the amount of time needed to train LLMs is known as the transformer model, or simply “transformers.” Transformers apply a set of mathematical techniques, called attention or self-attention, to capture relationships in sequential data called tokens, such as words in a sentence. Transformers are able to detect subtle causal relationships between data elements in a series, including how even distant data elements influence and depend on each other. Unlike previous models that have to process tokens sequentially (e.g., Recurrent Neural Networks (RNNs)), transformers use an attention mechanism to process tokens simultaneously and calculate the attention weights, or strengths of relationships, between the tokens in successive layers. Because transformers can compute attention weights for all the tokens in parallel, the amount of time needed to train LLMs using transformers is greatly improved over other training models.

LLMs can be trained in two stages, pre-training and fine-tuning. During the pre-training stage, LLMs are trained on massive datasets of unlabeled text data (or “unsupervised learning”) where transformers allow the LLMs to process and learn the patterns and relationships between words. During the fine-tuning stage, the LLMs can be fine-tuned for specific tasks or prompts, such as summarizing content, answering questions, and text completion. There are generalized LLMs that have been trained on sets of text data describing all types of content (e.g., data obtained from crawlers that scrape the public Internet). There are also specialized LLMs that have been trained on specialized sets of data that are specific to a particular type of content, such as travel or shopping. The orchestrator 132 can optionally be trained using these techniques.

Furthermore, the orchestrator 132 can optionally be trained or updated based on historical data comprising user 140 requests to the orchestrator 132 and/or user 140 requests to the automated interaction tools 134B, 136B. Training data can furthermore include orchestrator 132 or automated interaction tools 134B, 136B responses to the user 140 requests, and any subsequent user 140 actions. The orchestrator 132 can be configured to continually learn and improve its orchestration and combined outputs based on user 140 feedback and analysis of user 140 time spent or number of user 140 steps taken based on combined outputs produced by the orchestrator 132.

For example, the orchestrator 132 can be configured to conduct fine-tuning type training in order to adapt to particular customer network environments such as implemented by the architecture 100, and users thereof such as the user 140. The orchestrator 132 can thereby improve its response orchestration over time and become customized to suit the circumstances presented by a particular architecture 100 and network 120.

In further aspects of FIG. 1, the one or more endpoint device(s) 110 can optionally be inside of the network 120, or otherwise can access, through one or more other networks, the resources located in the network 120. The network management device(s) 130 can provide network management and security functions for devices in the network 120 as well as for endpoint device(s) 110, such as an intrusion detection or prevention system (IDS/IPS), denial-of-service (DoS) attack protection, session monitoring, and other security services. Network 120 can comprise an enterprise network operated by a business, university, government agency or other entity.

In various examples, the endpoint device(s) 110 can comprise any devices that can connect to the network 120, either wirelessly or via direct cable connections. For example, the endpoint device(s) 110 may include but are not limited to mobile telephones, personal digital assistants (PDAs), media players, tablet computers, gaming devices, smart watches, hotspots, personal computers (PCs) such as laptops, desktops, or workstations, or any other type of computing or communication device. In other examples, the endpoint device(s) 110 may comprise vehicle-based devices, wearable devices, wearable materials, virtual reality (VR) devices, smart watches, smart glasses, clothes made of smart fabric, etc.

In various examples, the network 120 can be a public cloud, a private cloud, or a hybrid cloud and may host a variety of resources such as the virtual machine(s) 121, application platform(s) 122, database(s)/storage(s) 123, server(s) 124, firewalls 125, VPNs 126, routers/switches 127, Wi-Fi Access Points 128, etc. The server(s) 124 may include the pooled and centralized server resources related to application content, storage, and/or processing power. The application platform(s) 122 may include one or more cloud environments for designing, building, deploying and managing custom business applications. Virtual desktop(s) may image operating systems and applications of a physical device, e.g., any of endpoint device(s) 110, and allow users to access their desktops and applications from anywhere on any kind of endpoint devices. The database(s)/storage(s) 123 may include one or more of file storage, block storage or object storage.

It should be understood that the virtual machine(s) 121, application platform(s) 122, database(s)/storage(s) 123, server(s) 124, firewalls 125, VPNs 126, routers/switches 127, Wi-Fi Access Points 128 illustrate multiple functions, available services, and available resources provided by the network 120. Although shown as individual network participants in FIG. 1, the virtual machine(s) 121, application platform(s) 122, database(s)/storage(s) 123, server(s) 124, firewalls 125, VPNs 126, routers/switches 127, and Wi-Fi Access Points 128 can be integrated and deployed on one or more computing devices and/or servers in the network 120.

In implementations, the network 120 can comprise any types of firewalls 125. Example firewalls 125 include a packet filtering firewall that operates inline at junction points of network devices such as routers and switches. A packet filtering firewall can compare each packet received to a set of established criteria, such as the allowed IP addresses, packet type, port number and other aspects of the packet protocol headers. Packets that are flagged as suspicious are dropped and not forwarded. Example firewalls 125 may further include a circuit-level gateway that monitors transmission control protocol (TCP) handshakes and other network protocol session initiation messages across the network to determine whether the session being initiated is legitimate. Example firewalls 125 may further include an application-level gateway (also referred to as a proxy firewall) that filters packets not only according to the service as specified by the destination port but also according to other characteristics, such as the hypertext transfer protocol (HTTP) request string. Yet another example firewall may be a stateful inspection firewall that monitors an entire session for a state of a connection, while also checking internet protocol (IP) addresses and payloads for more thorough security. A next-generation firewall, as another example firewall, can combine packet inspection with stateful inspection and can also include some variety of deep packet inspection (DPI), as well as other network security systems, such as IDS/IPS, malware filtering and antivirus functions.

In various examples, the illustrated elements of the network 120 can be deployed as one or more hardware-based appliances, software-based appliances, and/or cloud-based services. A hardware-based appliance may also be referred to as network-based appliance or network-based firewall. The hardware-based appliance can act as a secure gateway between the network 120 and the endpoint device(s) 110 and can protect the devices/storages inside the perimeter of the network 120 from being attacked by malicious actors.

FIG. 2 illustrates an example orchestrator 210 and operations thereof, in accordance with various aspects of the technologies disclosed herein. The orchestrator 210 can implement the orchestrator 132 in some examples. The orchestrator 210 comprises request translation 211, orchestration 212, planning 213, routing 214, assistant interaction handler(s) 215, 216, and 217, and output synthesizer 218. FIG. 2 further comprises a user 200, a request 202 supplied by the user 200 to the orchestrator 210, and a combined output 204 provided by the orchestrator 210 to the user 200. FIG. 2 further comprises example data sources including network management tool data 222 and network topology 224, which can be used in connection with orchestrator 210 operations. FIG. 2 further comprises example assistants 232, 234, 236, which can implement automated interaction tools such as automated interaction tools 134B, 136B in FIG. 1, and which can interact with the orchestrator 210 in accordance with this disclosure.

In example operations of the orchestrator 210 illustrated in FIG. 2, the orchestrator 210 can receive a request 202 from the user 200, e.g., from an administrator or information technology (IT) employee responsible for a network including the orchestrator 210. The request 202 may indicate a question or help request. For example, the request 202 may indicate a question such as, “why is the network running slow?” or, “what is the most urgent security vulnerability in the network?” The request 202 can comprise, e.g., a text input, voice input, or application programming interface (API) input.

The request 202 can initially be processed by request translation 211 in order to identify a user intent corresponding to the request 202. The request 202 may potentially be ambiguous, and even if not ambiguous, the request 202 may not straightforwardly identify a problem or question that can be addressed by the orchestrator 210. Request translation 211 can be configured to translate the request 202 to identify a request intent. The request intent can comprise a disambiguated user 200 intent for network information or for operations which are within the capabilities of the orchestrator 210. The request intent can be provided to the orchestration 212.

Orchestration 212 and planning 213 can be configured to determine, based on the translated request intent, an orchestration strategy to respond to the request 202. The orchestration strategy can comprise a response goal determined by orchestration 212 and an action plan determined by planning 213. The response goal can comprise, e.g., a goal of providing determined information to the user 200 in response to the request 202, or a goal of performing one or more actions (such as modifying network configuration information) in response to the request 202. The action plan can comprise, e.g., one or more operations to be performed to achieve the response goal. The action plan can include interactions between the orchestrator 210 and the assistants 232, 234, 236, as well as any pre or post processing conducted by the output synthesizer 218. Example preprocessing can include producing interaction inputs for the assistants 232, 234, 236, while example postprocessing can include combining, by the output synthesizer 218, interaction outputs from the assistants 232, 234, 236. Orchestration 212 and planning 213 can determine an orchestration strategy based on available network 120 information, including, e.g., network management tool data 222 and network topology 224.

Routing 214 can be configured to route interaction data as determined by orchestration 212 and planning 213 to applicable assistant interaction handler(s) 215, 216, and 217, so that assistant interaction handler(s) 215, 216, and 217 can interact with their respective assistants 232, 234, 236 to gather any output information. The assistant interaction handler(s) 215, 216, and 217 can carry out one interaction or a series of interactions with their respective assistants 232, 234, 236, depending on the orchestration strategy. In some cases, data gathered via one or more interactions with assistants 232, 234, 236 can be used to update an orchestration strategy, and subsequent interactions with assistants 232, 234, 236 can implement an updated orchestration strategy.

Network assistant outputs can be received from assistants 232, 234, 236 in response to network assistant requests. The received network assistant outputs can be combined or otherwise processed by the output synthesizer 218, thereby generating a combined output 204 in accordance with the orchestration strategy for the request 202. The combined output 204 can be provided to the user 200 in response to the request 202.

In an example implementation, one or more of the illustrated components of the orchestrator 210 can be implemented as trained LLM type machine learning modules. For example, request translation 211 can be trained on training data comprising historical requests and corresponding identified request intents. In an alternative or additional aspect, request translation 211 can be configured to supply one or more dialogs to gather any needed request information, which can be used to determine the request intent. A draft request intent can optionally be presented to the user 200 for approval.

Orchestration 212, planning 213, routing 214, assistant interaction handler(s) 215, 216, and 217, and output synthesizer 218 can also be implemented via one or more AI or ML modules. These components can learn over time, e.g., based on user 200 feedback, which combined outputs more effectively addressed user 200 requests. The orchestration strategies, or aspects of orchestration strategies, which lead to more effective combined outputs can be preferred in subsequent operations of the orchestrator 210.

In some examples, the combined output 204 can optionally comprise a text or graphic display including information and/or instructions for the user 200. In other examples, the combined output 204 can optionally comprise one or more actions for user 200 approval, and the orchestrator 210can be configured to interact with network management tools to conduct the suggested actions upon approval thereof. In still further examples, the combined output 204 can optionally comprise one or more automated interactions with one or more network management tools, without necessarily obtaining advance approval thereof.

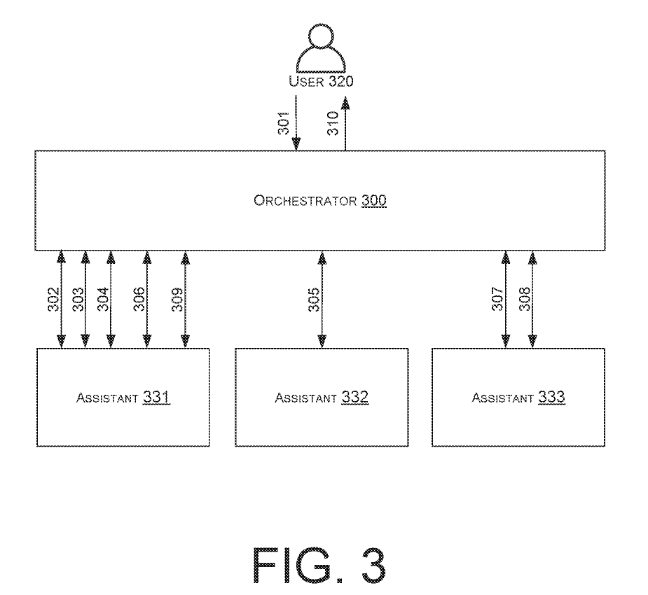

FIG. 3 illustrates an example series of interactions which may be performed by an orchestrator 300, the series of interactions including interactions with a user 320 and interactions with multiple different assistants 331, 332, 333, in accordance with various aspects of the technologies disclosed herein. The orchestrator 300 is an example orchestrator which may optionally be configured according to FIG. 2, and which may optionally implement the orchestrator 132 in FIG. 1 in some embodiments.

The illustrated example series of interactions comprises interactions 301, 302, 303, 304, 305, 306, 307, 308, 309, and 310. In the example provided in FIG. 3, the orchestrator 300 may engage in a first interaction 301 with the user 320. For example, the orchestrator 300 may receive a request from the user 320. The orchestrator 300 may then translate the request to determine a request intent, and orchestrate, plan, and route interactions with the assistants 331, 332, 333 in order to generate a combined response to the request. The interactions with the assistants 331, 332, 333 can comprise, e.g., submitting different respective network assistant requests to the different respective assistants 331, 332, 333, and receiving different respective network assistant outputs from the different respective assistants 331, 332, 333.

The orchestrator 300 may for example first perform a series of interactions 302, 303, and 304 with assistant 331. The orchestrator 300 may next perform an interaction 305 with assistant 332. The orchestrator 300 may next perform an interaction 306 with assistant 331. The orchestrator 300 may next perform a series of interactions 307, 308 with assistant 333. The orchestrator 300 may next perform an interaction 309 with assistant 331. The orchestrator 300 may next generate a combined output based on network assistant outputs from one or more of the interactions 302, 303, 304, 305, 306, 307, 308, 309, and the orchestrator 300 may next engage in interaction 310 in which the combined output is provided to the user 320.

In FIG. 3, each subsequent interaction of the interactions 302, 303, 304, 305, 306, 307, 308, 309 can optionally be based on any previous interactions of the interactions 302, 303, 304, 305, 306, 307, 308, 309. For example, the orchestrator 300 can configure interaction data, or plan and sequence interactions themselves based on outputs from previous interactions.

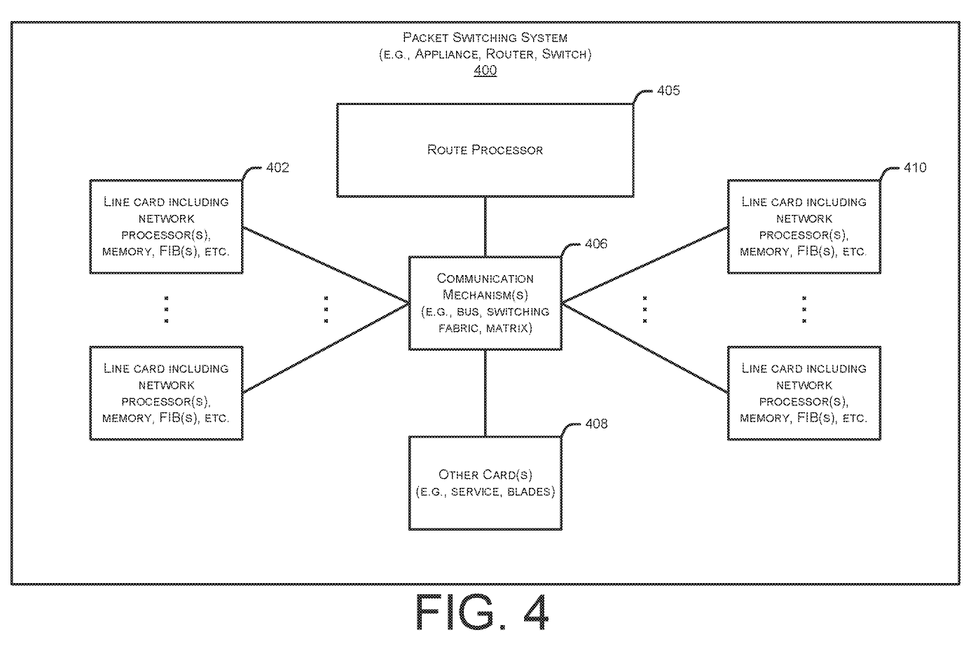

FIG. 4 illustrates an example packet switching system 400 that can be utilized to implement devices of a network in accordance with various aspects of the technologies disclosed herein. In some examples, the packet switching system 400 can comprise a device that may be managed by a network configuration tool comprising an AI assistant. In some examples, the packet switching system 400 can be implemented as one or more packet switching device(s). The packet switching system 400 may be employed in a network, for example, the packet switching system 400 can implement a router configured to process network traffic by receiving and forwarding packets.

In some examples, the packet switching system 400 may comprise multiple line card(s) 402, 410, each with one or more network interfaces for sending and receiving packets over communications links (e.g., possibly part of a link aggregation group). The packet switching system 400 may also have a control plane with one or more processing elements, e.g., the route processor 405 for managing the control plane and/or control plane processing of packets associated with forwarding of packets in a network. The packet switching system 400 may also include other cards 408 (e.g., service cards, blades) which include processing elements that are used to process (e.g., forward/send, drop, manipulate, change, modify, receive, create, duplicate, apply a service) packets associated with forwarding of packets in a network.

The packet switching system 400 may comprise a communication mechanism 406 (e.g., bus, switching fabric, and/or matrix, etc.) for allowing the different entities such as the multiple line card(s) 402, 410, the route processor 405, and the other cards 408 to communicate. The communication mechanism 406 can optionally be hardware-based. Line card(s) 402, 410 may perform the actions of being both an ingress and/or an egress line card of the line card(s) 402, 410, with regard to multiple packets and/or packet streams being received by, or sent from, the packet switching system 400.

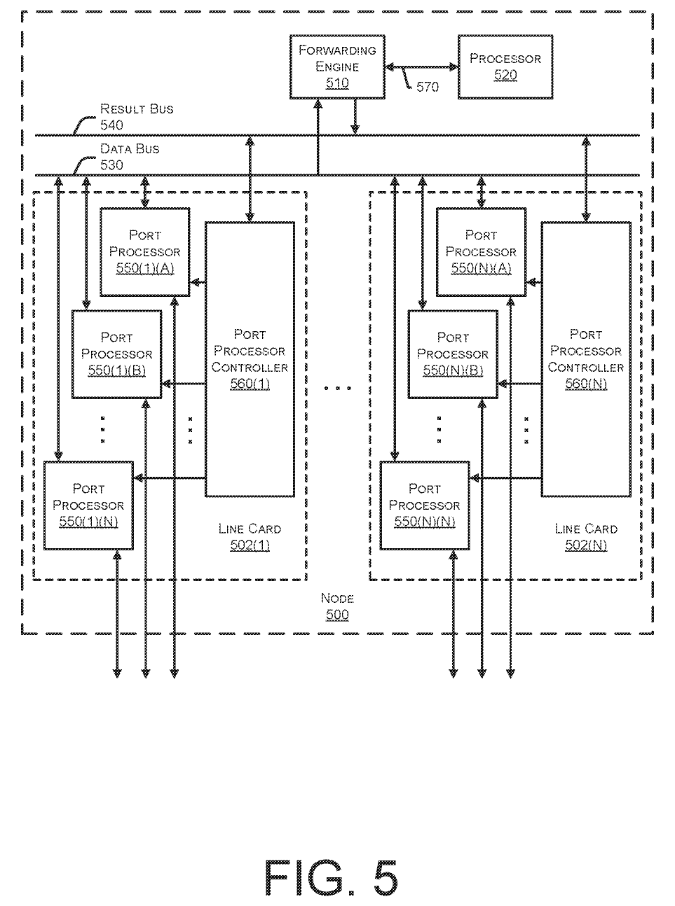

FIG. 5 illustrates an example node that can be utilized to implement devices in accordance with various aspects of the technologies disclosed herein. For example, the node 500 can implement a device that may be configured managed by network configuration tool comprising an AI assistant. In some examples, node 500 may include any number of line cards, e.g., line cards 502(1)- 502(N), where N may be any integer greater than 1, and wherein the line cards are communicatively coupled to a forwarding engine 510 (also referred to herein as an encryption engine) and/or a processor 520 via a data bus 530 and/or a result bus 540.

Line cards may include any number of port processors, for example, line card 502(1) comprises port processors 550(1)(A) - 550(1)(N), and line card 502(N) comprises port processors 550(N)(A) - 550(N)(N). The port processors can be controlled by port processor controllers, e.g., port processor controllers 560(1), 560(N), respectively.

Additionally, or alternatively, the forwarding engine 510 and/or the processor 520 can be coupled to one another via the data bus 530 and the result bus 540 and may also be communicatively coupled to one another by a communications link 570. The processors (e.g., the port processor(s) 550(1)(A) - 550(1)(N) and 550(N)(A) - 550(N)(N), and/or the port processor controller(s) 560(1), 560(N)) of each line card 502(1), 502(N) may optionally be mounted on a single printed circuit board.

When a packet or packet and header are received, the packet or packet and header may be identified and analyzed by the node 500 in the following manner. Upon receipt, a packet (or some or all of its control information) or packet and header may be sent from one of port processor(s) at which the packet or packet and header was received and to one or more of those devices coupled to the data bus 530 (e.g., others of the port processor(s), the forwarding engine 510 and/or the processor 520). Handling of the packet or packet and header may be determined, for example, by the forwarding engine 510.

For example, the forwarding engine 510 may determine that the packet or packet and header should be forwarded to one or more of the other port processors. This may be accomplished by indicating to corresponding one(s) of port processor controllers that a copy of the packet or packet and header held in the given one(s) of port processor(s) should be forwarded to the appropriate other one of port processor(s). Additionally, or alternatively, once a packet or packet and header has been identified for processing, the forwarding engine 510, the processor 520, and/or the like may be used to process the packet or packet and header in some manner and/or may add packet security information in order to secure the packet.

On a node 500 sourcing a packet or packet and header, processing may include, for example, encryption of some or all of the packet or packet and header information, the addition of a digital signature, and/or some other information and/or processing capable of securing the packet or packet and header. On a node 500 receiving a packet or packet and header, the processing may be performed to recover or validate the packet or packet and header information that has been secured.

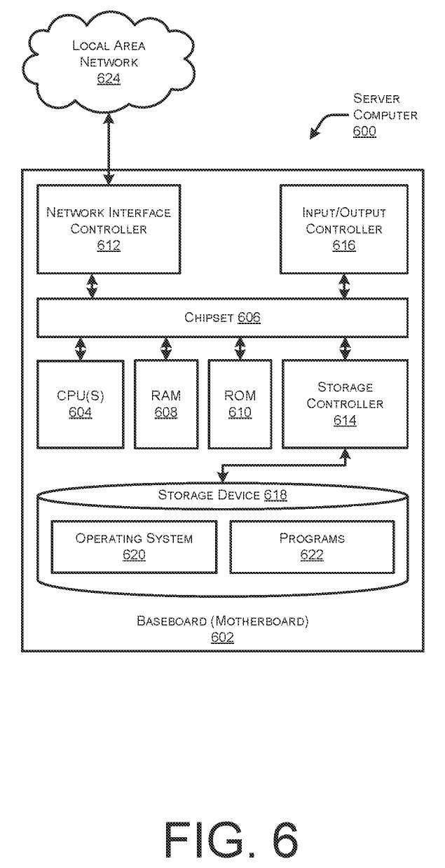

FIG. 6 illustrates an example computer hardware architecture that can implement devices in accordance with various aspects of the technologies disclosed herein. For example, the illustrated computer hardware architecture can implement a network management device 130 which may provide a console comprising an orchestrator 132 and network management tools 134A, 136A comprising automated interaction tools 134B, 136B, or any of the other network devices described herein in some embodiments. The computer architecture shown in FIG. 6 illustrates a conventional server computer 600, however the computer architecture can optionally implement any other computing devices such as a router, a workstation, desktop computer, laptop, tablet, network appliance, e-reader, smartphone, or other computing device. The illustrated computer architecture can be utilized to execute any of the software components presented herein.

The server computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the server computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the server computer 600. The chipset 606 can further provide an interface to a computer-readable storage medium such as a read-only memory (“ROM”) 610 or non-volatile RAM (“NVRAM”) for storing basic routines that help to start up the server computer 600 and to transfer information between the various components and devices. The ROM 610 or NVRAM can also store other software components necessary for the operation of the server computer 600 in accordance with the configurations described herein.

The server computer 600 can operate in a networked environment using logical connections to remote computing devices and computer systems through a network, such as the LAN 624. The chipset 606 can include functionality for providing network connectivity through a NIC 612, such as a gigabit Ethernet adapter. The NIC 612 is capable of connecting the server computer 600 to other computing devices over the LAN 624. It should be appreciated that multiple NICs 612 can be present in the server computer 600, connecting the computer to other types of networks and remote computer systems.

The server computer 600 can be connected to a storage device 618 that provides non-volatile storage for the server computer 600. The storage device 618 can store an operating system 620, programs 622, and data, to implement any of the various components described in detail herein.

The storage device 618 can be connected to the server computer 600 through a storage controller 614 connected to the chipset 606. The storage device 618 can comprise one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the server computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 600 can further read information from the storage device 618 by detecting the physical states or characteristics of one or more particular locations within the physical storage units.

In addition to the mass storage device 618 described above, the server computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 600. In some examples, the operations performed by the computing elements illustrated in FIGS. 1-3, 7, and or any components included therein, may be supported by one or more devices similar to server computer 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the server computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the server computer 600.

In one embodiment, the storage device 618 or other computer-readable storage media is encoded with computer-executable instructions which, when loaded into the server computer 600, transform the computer from a general-purpose computing system into a special-purpose computer capable of implementing the embodiments described herein. These computer-executable instructions transform the server computer 600 by specifying how the CPUs 604 transition between states, as described above.

According to one embodiment, the server computer 600 has access to computer-readable storage media storing computer-executable instructions which, when executed by the server computer 600, can implement the architectures and perform the various processes described with regard to FIGS. 1-3 and 7. The server computer 600 can also include computer-readable storage media having instructions stored thereupon for performing any of the other computer-implemented operations described herein.

The server computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat panel display, a digital projector, a printer, or other type of output device. It will be appreciated that the server computer 600 might not include all of the components shown in FIG. 6, can include other components that are not explicitly shown in FIG. 6, or might utilize an architecture completely different than that shown in FIG. 6.

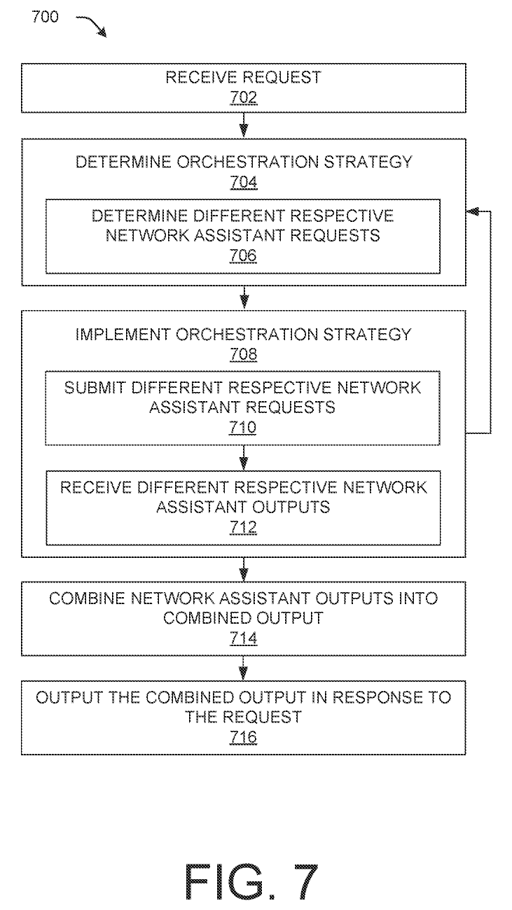

FIG. 7 is a flow diagram of an example method 700 performed at least partly by a computing device, such as the server computer 600, optionally in conjunction with other computing devices. The logical operations described herein with respect to FIG. 7 may be implemented (1) as a sequence of computer-implemented acts or program modules running on a computing system and/or (2) as interconnected machine logic circuits or circuit modules within the computing system. In some examples, the method 700 may be performed by a system comprising one or more processors and one or more non-transitory computer-readable media storing computer-executable instructions that, when executed by the one or more processors, cause the one or more processors to perform the method 700.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof.

It should also be appreciated that more or fewer operations might be performed than shown in FIG. 7 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by fewer components, more components, different components, or any configuration of components.

FIG. 7 is a flow diagram that illustrates an example method involving an orchestrator, in accordance with various aspects of the technologies disclosed herein. In an example embodiment, the illustrated method can be performed by a server such as illustrated in FIG. 6, or by network management device(s) 130 comprising an orchestrator 132, as shown in FIG. 1. The orchestrator 132 can be implemented as illustrated in FIG. 2, and the network management device(s) 130 can further implement, e.g., a combined network management console equipped with access to the example network management tools 134A, 136A and their respective automated interaction tools 134B, 136B. The orchestrator 132 can be implemented as a trained machine learning module, and the different respective automated interaction tools / assistants can also comprise different respective trained machine learning modules.

At operation 702, the orchestrator 132 can be configured to receive a request, e.g., from the user 140. The request can be any of a wide variety of requests, such as a request for information regarding one or more network 120 elements, a request for information or help in fixing or modifying network 120 elements, customer service type requests, or any other request pertaining to network troubleshooting, security, reconfiguration, or the like. One example request may comprise a request for information or troubleshooting related to a traffic speed in the network 120 comprising the orchestrator 132.

At operation 704, the orchestrator 132 can be configured to determine an orchestration strategy for responding to the request. The orchestration strategy can involve interactions with multiple different assistants / automated interaction tools 134B, 136B. Operation 704 can comprise, at operation 706, determining, by the orchestrator 132 in response to the request, different respective network assistant requests for different respective assistants / automated interaction tools 134B, 136B. In the example of the request for information or troubleshooting related to a traffic speed in the network 120, at least one of the different respective network assistant requests may comprise a request for packet loss information at one or more network elements of the network 120, such as the server(s) 124, firewalls 125, VPNs 126, or other network elements.

Some example different respective assistants automated interaction tools for which network assistant requests may be determined can include, e.g., at least two of: an assistant for a secure client network management tool to manage a secure client function installed on endpoint devices 110 of the network 120, an assistant for a user authentication network management tool to manage a user authentication function of the network 120, an assistant for a firewall network management tool to manage a firewall 125 of the network 120, or an assistant for a Wi-Fi access point network management tool to manage a Wi-Fi access point 128 of the network 120. The different respective assistants / automated interaction tools 134B, 136B can optionally be for different respective network management tools 134A, 136A included in a bundle of related network management tools.

Network assistant requests determined at operation 706 can optionally comprise a series of network assistant requests generated by the orchestrator 132 in a dialog with a respective assistant / automated interaction tool. For example, a series of interactions 302, 303, and 304 illustrated in FIG. 3 can comprise a series of network assistant requests generated by the orchestrator 300 in a dialog with the assistant 331. The dialog may comprise network assistant requests from orchestrator 300 followed network assistant outputs from the assistant 331, wherein each subsequent network assistant request may be based in part on a previous output from the assistant 331. In general, any second or subsequent request of different respective network assistant requests generated by the orchestrator 132 can be based on at least one first or previous output of different respective network assistant outputs.

At operation 708, the orchestrator 132 can be configured to implement the orchestration strategy determined at operation 704. For example, the orchestrator 132 can submit, at operation 710, the different respective network assistant requests to the different respective assistants / automated interaction tools 134B, 136B. The orchestrator 132 can furthermore receive, at operation 712, different respective network assistant outputs from the different respective assistants / automated interaction tools 134B, 136B. In some cases, the orchestrator 132 can return to operation 704 to conduct further determinations of orchestration strategy and can then carry out further interactions with the assistants / automated interaction tools 134B, 136B, in a feedback loop approach that allows for adapting orchestration strategy based on network assistant outputs.

At operation 714, the orchestrator 132 can be configured to combine the different respective network assistant outputs received at operation 712 into a combined output. For example, with reference to FIG. 2, the output synthesizer 218 can combine the different respective network assistant outputs into a combined output 204. The combined output can optionally comprise a modified output which modifies one or more of the different respective network assistant outputs, e.g., by applying any modification processing thereto. At operation 716, the orchestrator 132 can output the combined output in response to the request received at operation 702. For example, the orchestrator 132 can provide a text or graphic display of the combined output to the user 140.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, comprising:
receiving a request by an orchestrator;
determining, by the orchestrator in response to the request, different respective network assistant requests for different respective network management tool assistants;
submitting, by the orchestrator, the different respective network assistant requests to the different respective network management tool assistants;
receiving, by the orchestrator, different respective network assistant outputs from the different respective network management tool assistants;
combining, by the orchestrator, the different respective network assistant outputs into a combined output; and
outputting, by the orchestrator, the combined output in response to the request.

2. The method of claim 1, wherein the orchestrator comprises a trained machine learning module, and wherein the different respective network management tool assistants comprise different respective trained machine learning modules.

3. The method of claim 1, wherein a respective network assistant request for a respective network management tool assistant comprises a series of network assistant requests generated by the orchestrator in a dialog with the respective network management tool assistant.

4. The method of claim 1, wherein the orchestrator comprises a trained machine learning module configured for fine-tuning training based on received requests, wherein the orchestrator thereby becomes customized for a network environment in which the orchestrator is deployed.

5. The method of claim 1, wherein the combined output comprises a modified output which modifies one or more of the different respective network assistant outputs.

6. The method of claim 1, wherein the different respective network management tool assistants comprise at least two of:
a network management tool assistant for a secure client network management tool to manage a secure client function installed on endpoint devices;
a network management tool assistant for a user authentication network management tool to manage a user authentication function;
a network management tool assistant for a firewall network management tool to manage a firewall; or
a network management tool assistant for a Wi-Fi access point network management tool to manage a Wi-Fi access point.

7. The method of claim 1, wherein the request comprises a request for information related to a traffic speed in a network comprising the orchestrator, and wherein at least one of the different respective network assistant requests comprises a request for packet loss information at one or more network elements of the network.

8. The method of claim 1, wherein the different respective network management tool assistants are for different respective network management tools included in a bundle of related network management tools.

9. A device comprising:
one or more processors; and
one or more non-transitory computer-readable media storing computer-executable instructions that, when executed by the one or more processors, cause the one or more processors to perform operations comprising:
receiving a request by an orchestrator;
determining, by the orchestrator in response to the request, different respective network assistant requests for different respective network management tool assistants;
submitting, by the orchestrator, the different respective network assistant requests to the different respective network management tool assistants;
receiving, by the orchestrator, different respective network assistant outputs from the different respective network management tool assistants;
combining, by the orchestrator, the different respective network assistant outputs into a combined output; and
outputting, by the orchestrator, the combined output in response to the request.

10. The device of claim 9, wherein the orchestrator comprises a trained machine learning module, and wherein the different respective network management tool assistants comprise different respective trained machine learning modules.

11. The device of claim 9, wherein a respective network assistant request for a respective network management tool assistant comprises a series of network assistant requests generated by the orchestrator in a dialog with the respective network management tool assistant.

12. The device of claim 9, wherein the operations further comprise determining, by the orchestrator, at least one second request of the different respective network assistant requests based on at least one first output of the different respective network assistant outputs.

13. The device of claim 9, wherein the combined output comprises a modified output which modifies one or more of the different respective network assistant outputs.

14. The device of claim 9, wherein the different respective network management tool assistants comprise at least two of:
a network management tool assistant for a secure client network management tool to manage a secure client function installed on endpoint devices;
a network management tool assistant for a user authentication network management tool to manage a user authentication function;
a network management tool assistant for a firewall network management tool to manage a firewall; or
a network management tool assistant for a Wi-Fi access point network management tool to manage a Wi-Fi access point.

15. The device of claim 9, wherein the request comprises a request for information related to a traffic speed in a network comprising the orchestrator, and wherein at least one of the different respective network assistant requests comprises a request for packet loss information at one or more network elements of the network.

16. The device of claim 9, wherein the different respective network management tool assistants are for different respective network management tools included in a bundle of related network management tools.

17. A method comprising:
receiving a request by an orchestrator comprising a first trained machine learning module;
determining, by the orchestrator in response to the request, different respective network assistant requests for different respective network management tool assistants, wherein the different respective network management tool assistants comprise different respective second trained machine learning modules;
submitting, by the orchestrator, the different respective network assistant requests to the different respective network management tool assistants;
receiving, by the orchestrator, different respective network assistant outputs from the different respective network management tool assistants;
generating, by the orchestrator, a combined output based on one or more of the different respective network assistant outputs; and
outputting, by the orchestrator, the combined output in response to the request.

18. The method of claim 17, wherein a respective network assistant request for a respective network management tool assistant comprises a series of network assistant requests generated by the orchestrator in a dialog with the respective network management tool assistant.

19. The method of claim 17, further comprising determining, by the orchestrator, at least one second request of the different respective network assistant requests based on at least one first output of the different respective network assistant outputs.

20. The method of claim 17, wherein the different respective network management tool assistants comprise:
a network management tool assistant for a secure client network management tool to manage a secure client function installed on endpoint devices;
a network management tool assistant for a user authentication network management tool to manage a user authentication function;
a network management tool assistant for a firewall network management tool to manage a firewall; and
a network management tool assistant for a Wi-Fi access point network management tool to manage a Wi-Fi access point.
